(19) United States
(12) Patent Application Publication
(10) Pub. No.: US 2008/0243299 A1
(43) Pub. Date: Oct. 2, 2008

(54) Machine tool control system

(75) Inventors: Barry D. Johnson, Thousand Oaks, CA (US); Kurt P. Zierhut, Camarillo, CA (US)

Correspondence Address: MCDERMOTT WILL & EMERY LLP, 18191 VON KARMAN AVE., SUITE 500, IRVINE, CA, 92612-7108, US

(73) Assignee: HAAS AUTOMATION, INC., Oxnard, CA (US)

(21) Appl. No.: 11/729,125

(22) Filed: Mar. 27, 2007

(51) Int. Cl. G06F 19/00

(52) U.S. Cl. 700/169

(57) ABSTRACT

A machine tool controller is provided that includes a processor configured to execute a sequence of instructions in accordance with an operating program and a user program. A volatile memory temporarily stores instructions and data during execution of the sequence of instructions by the processor, and is coupled to the processor via a first interface. A first non-volatile memory stores the operating program and is coupled to the processor via a second interface. A second non-volatile memory stores the user program and is coupled to the processor via a third interface. A video controller is configured to control a user display in accordance with display data generated by the processor and is coupled to the processor via a fourth interface. A dual-port memory is coupled to the processor via a fifth interface and couples a serial bus controller configured to control communications with an external device via a serial bus to the processor. An external bus interface is configured to communicate control commands for controlling a machine tool generated by the processor via an external bus and is coupled to said processor via a sixth interface.

### BACKGROUND OF THE INVENTION

The invention concerns machine tools and, in particular, concerns a control system used in a computer numerical controlled (“CNC”) machine tool.

CNC machine tools use a computer control system to control the operation of the machine tool. An operator selects a user program containing a sequence of instructions that is executed by the control system to operate the machine tool in a desired manner. Each instruction directs the machine tool to perform an action such as selecting a particular tool, positioning the tool or the workpiece, setting a rate of movement of the tool or the workpiece, etc. Using sequences of these instructions, CNC machine tools perform complex machining tasks with minimal human interaction. By shifting operation of the machine tool from a manual mode performed by a machinist to a computer controlled mode, complex machining tasks become repeatable with minimal variation between end products.

As the capabilities of machine tools improve, the complexity of desired machining tasks increases. This increase in complexity results in larger user programs being needed to execute the desired machining tasks. Accordingly, a need exists to improve the storage capabilities of the control systems to increase both capacity and speed. Furthermore, a need exists to broaden the connectivity options for interfacing with the control system and to improve flexibility for adapting the control system to a variety of possible hardware.

### BRIEF SUMMARY OF THE INVENTION

The invention addresses the foregoing needs by providing a unique combination of components to form a machine tool control system. The invention facilitates the use of multiple types storage media to improve performance of the overall system. In addition, the use of reconfigurable components provides flexibility to accommodate future system configurations.

According to one aspect of the invention, a machine tool controller is provided that includes a processor configured to execute a sequence of instructions in accordance with an operating program and a user program. A volatile memory temporarily stores instructions and data during execution of the sequence of instructions by the processor, and is coupled to the processor via a first interface. A first non-volatile memory stores the operating program and is coupled to the processor via a second interface. A second non-volatile memory stores the user program and is coupled to the processor via a third interface. A video controller is configured to control a user display in accordance with display data generated by the processor and is coupled to the processor via a fourth interface. A dual-port memory is coupled to the processor via a fifth interface and couples a serial bus controller configured to control communications with an external device via a serial bus to the processor. An external bus interface is configured to communicate control commands for controlling a machine tool generated by the processor via an external bus and is coupled to said processor via a sixth interface.

The foregoing summary of the invention has been provided so that the nature of the invention can be understood quickly. A more detailed and complete understanding of the preferred embodiments of the invention can be obtained by reference to the following detailed description of the invention together with the associated drawings.

### BRIEF DESCRIPTION OF THE DRAWINGS

FIG. 1 is a block diagram depicting components of a computer numerical control machine tool.

FIG. 2 is a block diagram depicting components of a control system within a computer numerical control machine tool.

FIG. 3 is a block diagram depicting components of a machine tool controller within a computer numerical control machine tool.

### DETAILED DESCRIPTION OF THE INVENTION

The detailed description of the invention set forth below in connection with the associated drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without all of the specific details contained herein. In some instances, well known structures and components are shown in block diagram form in order to avoid obscuring the concepts of the invention.

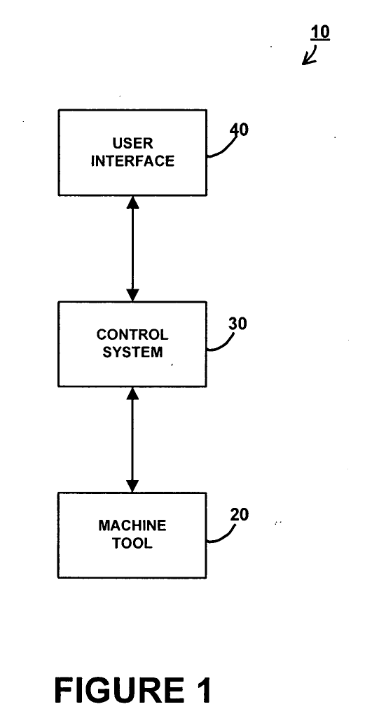

FIG. 1 is a block diagram depicting components of a CNC machine tool 10. As depicted in FIG. 1, CNC machine tool 10 includes a machine tool 20, a control system 30 and a user interface 40. Briefly, machine tool 20 processes a workpiece in accordance with commands received from control system 30. Control system 30 issues the commands based on code executed within control system 30 and/or input received from an operator via user interface 40. User interface 40 allows the operator to control and monitor the operation of CNC machine tool 10.

Machine tool 20 represents a mechanical system that processes a workpiece into a desired form using one or more cutting tools. The workpiece and the cutting tools are positioned and operated using motors, actuators, servos, and other mechanisms known to those skilled in the art. Representative examples of machine tool 20 include, but are not limited to, vertical machining centers, horizontal machining centers, turning centers, multi-axis machining centers, rotary tables, and indexers. Workpieces may be made of a wide range of materials, including metal, wood, plastic, etc. Those skilled in the art will recognize that the present invention is not limited to any particular type of machine tool or any particular workpiece material.

The operation of machine tool 20 is controlled by control system 30. Specifically, control system 30 provides machine tool 20 with signals to control the various mechanisms within machine tool 20 used to position and operate the workpiece and cutting tools. The control signals are generated based on code executed by one or more processors within control system 30. The executed code includes instructions from an operating program and a user program. The operating program includes code for controlling the overall functionality of CNC machine tool 10. For example, the operating program includes code for initiating operation of CNC machine tool 10 at power-on or reset conditions. The operating program also includes code for facilitating communication between components within CNC machine tool 10 and for managing computing resources (processor time, memory access, etc.) of CNC machine tool 10. The operating program also includes code for executing one or more user programs.

The user program includes instructions for performing a sequential process using machine tool 20 to shape a workpiece into a desired form. The sequential process includes steps for selecting and mounting a cutting tool, positioning the cutting tool, positioning the workpiece, moving/operating the cutting tool relative to the workpiece, moving/rotating the workpiece relative to the cutting tool, etc. According to one embodiment of the invention, the user program is created by an operator using G-code instructions. In alternative embodiments, the user program can be created automatically using software packages executed on a computer and also can be created using other formats besides G-code.

As noted above, user interface 40 allows an operator to control and monitor the operation of CNC machine tool 10. In particular, user interface 40 allows the operator to power-up or power-down the system, reset the system, select parameters unique to a specific CNC machine tool 10, enter a new user program, select from multiple existing user programs, monitor the position of the cutting tool, monitor the position of the workpiece, select positions for the cutting tool and/or the workpiece, select axes of movement for the cutting tool and/or the workpiece, enter individual instructions for operating machine tool 20, step through and troubleshoot user programs, etc. It is to be understood that the foregoing operations are intended to be examples and not to limit the scope of the invention. One skilled in the art will recognize other operations performed via a user interface of a CNC machine tool.

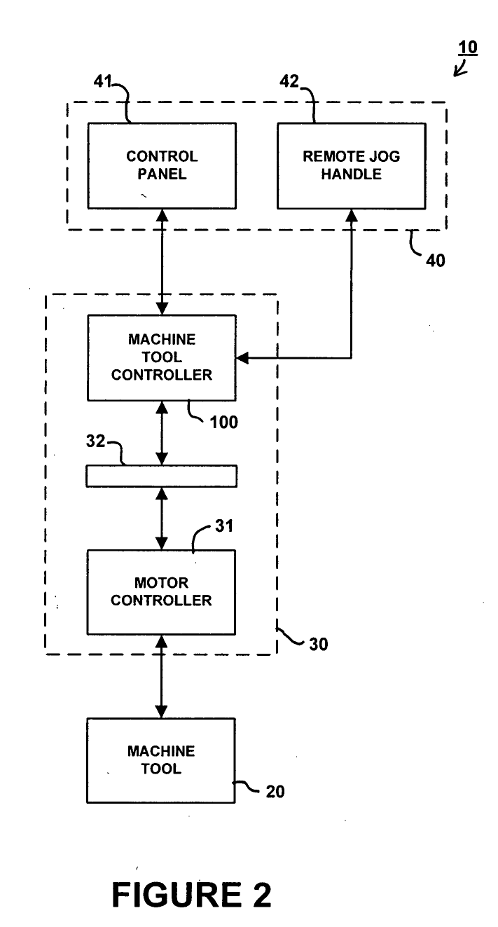

FIG. 2 provides additional details on components of CNC machine tool 10 according to one embodiment of the invention. FIG. 2 is a block diagram depicting components within control system 30 and user interface 40. As shown in FIG. 2, control system 30 includes motor controller 31, external bus 32 and machine tool controller 100. Machine tool controller 100 controls the operation of CNC machine tool 10 by executing an operating program and a user program. Based on the operating program and the user program, machine tool controller 100 generates and communicates control commands to motor controller 31 via external bus 32. Using a digital signal processor, motor controller 31 generates control signals based on the received control commands and communicates the control signals to machine tool 20 to control the operation of machine tool 20, as described above.

According to one embodiment of the invention, the digital signal processor of motor controller 31 is implemented using a Motorola 40 MHz MC68EC030. Alternative embodiments of the invention can use other processors and digital signal processors to implement the invention. In addition to the digital signal processor, motor controller 31 includes a non-volatile memory, such as flash memory, to store data and/or instructions used by the digital signal processor to generate the control signals. Motor controller 31 also includes one or more motion control peripherals used to communicate the control signal to machine tool 20. The motion control peripherals generate appropriate control signals for associated components of machine tool 20, such as motors, actuators, etc. Motor controller 31 further includes appropriate interfaces for cabling between motor controller 31 and machine tool 20. The various types of cabling used to communicate control signals are well known in the art and will not be described further herein.

According to one embodiment of the invention, the components of motor controller 31 are mounted and interconnected on a single printed circuit board. Using this arrangement, the connection and removal of motor controller 31 is simplified to facilitate easier maintenance and/or replacement of motor controller 31. While FIG. 2 depicts only one motor controller 31, it is to be understood that alternative embodiments of the invention may be implemented using multiple motor controllers 31. It is also to be understood that motor controller 31 can be connected to and communicate with a single motor, actuator, etc. or to multiple motors, actuators, etc. without departing from the scope of the invention.

Machine tool controller 100 and motor controller 31 communicate via external bus 32. External bus 32 is a communications bus configured to communicate data, instructions and bus control signals between machine tool controller 100 and motor controller 31 in order to convey control commands between the two components.

As shown in FIG. 2, user interface 40 includes control panel 41 and remote jog handle 42, according to one embodiment of the invention. Machine tool controller 100 controls the operation of CNC machine tool 10 in accordance with user input received from either control panel 41 or remote jog handle 42. Control panel 41 includes a user display, such as an LCD or CRT monitor, for displaying status and operational information on CNC machine tool 10 in accordance with display data generated by machine tool controller 100. According to one embodiment of the invention, the user display is implemented using a color LCD panel having 1024×768 resolution and 8-bit color. Control panel 41 further includes a key pad configured to be used by an operator to input commands and select user options either displayed on the user display or associated with a particular key on the key pad.

Remote jog handle 42 is an optional component of user interface 40. Remote jog handle includes a user interface mechanism which allows an operator to manually jog the position of the tool or workpiece within machine tool 20. According to one embodiment of the invention, the user interface mechanism includes one or more knobs which cause a command signal for jogging a position to be communicated to machine tool 20 when one of the knobs is rotated from a first position. Other user interface mechanisms such as joysticks, rollerballs, touchpads, etc. may be used in alternative embodiments of the invention.

Control panel 41 and remote jog handle 42 are each coupled to machine tool controller 100 so as to facilitate communication of user input and display data between the components. According to one embodiment of the invention, control panel 41 and remote jog handle 42 are coupled to machine tool controller 100 using serial communication interfaces such as RS-232. The invention is not limited to this particular communication interface and may be implemented using other communication mechanisms including but not limited to Ethernet, Universal Serial Bus (USB), wireless interfaces such as Bluetooth and IEEE 802.11x, etc. Additionally, control panel 41 may use a different communication mechanism than remote jog handle 42 to communicate with machine tool controller 100.

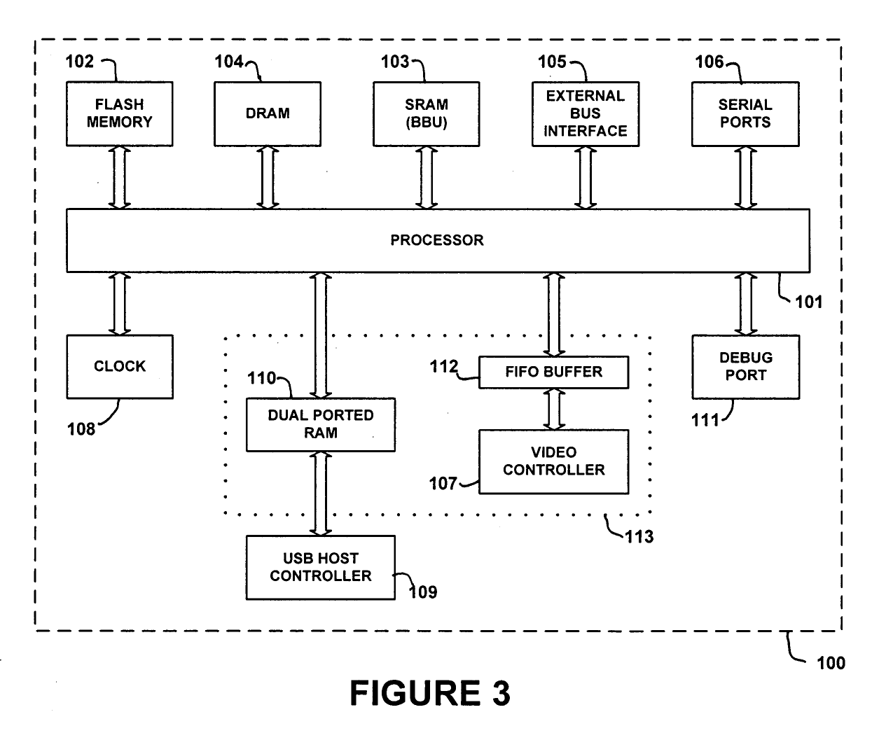

Turning to FIG. 3, machine tool controller 100 will now be described in more detail. As shown in FIG. 3, machine tool controller 100 includes processor 101, flash memory 102, battery-backed-up (“BBU”) static random access memory (“SRAM”) 103, dynamic random access memory 104. Machine tool controller 100 further includes external bus interface 105, serial ports 106, video controller 107, clock 108, USB host controller 109, dual-ported random access memory (“RAM”) 110, debug port 111, first-in-first-out buffer 112 and programmable gate array 113. As will be described in more detail below, the combination and arrangement of these components provides an improved machine tool controller over conventional controllers used in the industry.

Processor 101 is configured to execute a sequence of instructions from software code stored in flash memory 102 and SRAM 103 and temporarily stored in DRAM 104. Flash memory 102 is a non-volatile memory configured to store the operating program discussed above. In addition, to the operating program, flash memory 102 stores start-up code that is loaded and executed by processor 101 upon power-up or reset of CNC machine tool 10. The start-up code provides communication functionality to machine tool controller 100 to allow it to begin operating. While the present invention is not limited to using flash memory for storing the operating code, flash memory provides quick data access and durability suitable for the environments typically surrounding machine tools.

SRAM 103 is configured to store user programs either loaded into CNC machine tool 10 from another storage medium or programmed into CNC machine tool 10 via user interface 40. As indicated above, SRAM 103 is configured with a battery back-up system. Accordingly, the battery-powered SRAM 103 operates as a non-volatile memory. In addition to storing one or more user programs, SRAM 103 is configured to also store parameters unique to the specific CNC machine tool 10. These parameters may include configuration parameters unique due to the configuration of the system, parameters identifying optional equipment or alternative configurations currently in use in the system, etc. One of ordinary skill in the art will recognize that the invention is not limited to using battery-powered SRAM to store user programs and system parameter information. Other non-volatile memory media known to those skilled in the art may be used in place of battery-powered SRAM in alternative embodiments of the invention. In addition, user programs and system parameters may be stored in flash memory 102 in certain embodiments of the invention as well.

DRAM 104 is volatile memory that provides storage space for processor 101 to temporarily store instructions and data while executing the operating program and any user programs. DRAM 104 is not limited to any particular type of DRAM. For example, DRAM 104 may be implemented using DDR DRAM, DDR2 DRAM, as well as other types known to those skilled in the art.

External bus interface 105 couples processor 101 with external bus 32 to facilitate communication with motor controller 31. As noted above, external bus 32 is a communications bus configured to communicate data, instructions and bus control signals between machine tool controller 100 and motor controller 31 in order to convey control commands between the two components. External bus interface 105 provides physical and electrical connections to external bus 32.

Serial ports 106 are interfaces for serial communication using a serial communication standard such as RS-232. According to one embodiment of the invention, serial ports 106 include four serial ports for serial communications. The invention is not limited to this number of serial ports, however, and may be implemented having a different number of serial ports. As noted above, control panel 41 and remote jog handle 42 communicate with machine controller 100 via serial links such as RS-232 and therefore are coupled to respective ones of serial ports 106.

Video controller 107 is a video processor and memory configured to control the user display in control panel 41 in accordance with display data generated by processor 101. According to one embodiment of the invention, video controller 107 is configured as a dual-plane controller having a graphics plane and an overlapping text plane. Both the graphics plane and the text plane utilize 8-bit color. Implementing video controller 107 as a dual-plane controller simplifies the design and reduces the processing load of video controller 107.

In an alternative embodiment, FIFO buffer 112 is inserted into the data path between processor 101 and video controller 107. Using FIFO buffer 112 helps compensate for differences in processing speeds between video controller 107 and processor 101. FIFO buffer 112 may have any number of entries for buffering the data transfer. For example, one embodiment of the invention implements FIFO buffer 112 with 2000 entries.

Clock 108 is a battery powered real-time clock. Clock 108 provides the current time and date to processor 101. The time and date may be used for display purposes on the user display within control panel 41, to date/time stamp software loads and revisions, log errors, etc.

USB host controller 109 is configured to monitor and control communications with external USB devices. USB host controller 109 is coupled to processor 101 via dual-ported RAM 110. This arrangement allows the overhead associated with managing USB communications to be removed from processor 101 and maintained by USB host controller 109. In addition to managing USB devices, USB host controller 109 is optionally configured with a hard-disk interface such as IDE or other interfaces known to those skilled in the art. The capability of including a hard-disk in control system 30 provides the option of storing the operating program and/or the user programs in a different non-volatile memory other than flash memory 102 and SRAM 103. Alternatively, the hard-disk may be utilized for storing a back-up copy of the operating program and/or the user programs. One skilled in the art will recognize that other non-volatile memory media can be connected to machine tool controller 100 via USB host controller 109. For example different types of optical media can be used in place of a hard-disk without departing from the scope of the present invention. According to one embodiment of the invention, USB host controller 109 is implemented using a Cypress USB host microcontroller model number CY7C67300-100A1.

Debug port 111 is an optional feature that provides access to a debug interface within processor 101. Using debug port 111, an operator can connect to processor 101 and monitor internal trace and debug information. This feature provides significant advantages in troubleshooting performance/operational issues within machine tool controller 100. Access to trace information is also useful during various stages of software development.

According to one embodiment of the invention, a programmable gate array 113 is programmed to replace one or more of the components within machine tool controller 101. As shown in FIG. 3, programmable gate array 113 is configured as video controller 107, FIFO buffer 112 and dual-ported RAM 110. Using programmable gate 113 provides flexibility for future requirements and configurations. For example, video controller 107 can be quickly reconfigured for different user displays by changing the programming code stored in the load memory of the gate array. Programmable gate array 113 can be implemented using an Altera gate array model number EP2C5Q208C8, or other gate arrays known to those skilled in the art.

In a preferred embodiment, processor 101 is implemented using a ColdFire microprocessor manufactured by Freescale Semiconductor. For example, the ColdFire MCF547X family (model number MCF5475ZP266, for example) provides connectivity and functionality to implement a machine tool controller as described above. This processor family is configured with a DDR and SDR DRAM controller to interface with DRAM 104, an Inter-Integrated Circuit bus controller to interface with clock 108, a core debug interface for debug port 111, and as many as four programmable serial controllers for interfacing with serial ports 106.

The ColdFire MCF547X processor family also includes a general purpose local bus that is dynamically configurable (FlexBus). Using chip select signals from the processor, this interface is dynamically controlled to selectively facilitate communications with multiple components. According to one embodiment of the invention, the FlexBus interface is coupled to flash memory 102, SRAM 103, video controller 107/FIFO buffer 112, dual-ported RAM 110 and external bus interface 105. The flexibility afforded by the configurable bus provides a platform for incorporating a novel combination of components and functionality to implement machine tool controller 100.

According to one embodiment of the invention, the components of machine tool controller 100 described above are arranged and interconnected on a printed circuit board. While not explicitly described above, one skilled in the art will recognize that various known interface/connector components are used to interconnect the components described above. Examples include buffers, line drivers, transceivers, etc.

The foregoing description is provided to enable one skilled in the art to practice the various embodiments of the invention described herein. Various modifications to these embodiments will be readily apparent to those skilled in the art, and generic principles defined herein may be applied to other embodiments. Thus, the following claims are not intended to be limited to the embodiments of the invention shown and described herein, but are to be accorded the full scope consistent with the language of the claims. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A machine tool controller, comprising:
a processor configured to execute a sequence of instructions in accordance with an operating program and a user program;
a volatile memory configured to temporarily store instructions and data during execution of the sequence of instructions by said processor, wherein said volatile memory is coupled to said processor via a first interface;
a first non-volatile memory configured to store the operating program, wherein said first non-volatile memory is coupled to said processor via a second interface;
a second non-volatile memory configured to store the user program, wherein said second non-volatile memory is coupled to said processor via a third interface;
a video controller configured to control a user display in accordance with display data generated by said processor, wherein said video controller is coupled to said processor via a fourth interface;
a dual-port memory coupled to said processor via a fifth interface;
a serial bus controller configured to control communications with an external device via a serial bus, wherein said serial bus controller is coupled to said processor via said dual-port memory; and
an external bus interface configured to communicate control commands for controlling a machine tool generated by said processor via an external bus, wherein said external bus interface is coupled to said processor via a sixth interface.

2. The machine tool controller according to claim 1, wherein said volatile memory is a dynamic random access memory.

3. The machine tool controller according to claim 1, wherein said first non-volatile memory is flash memory.

4. The machine tool controller according to claim 1, wherein said second non-volatile memory is a battery-powered static random access memory.

5. The machine tool controller according to claim 1, wherein the serial bus is a Universal Serial Bus.

6. The machine tool controller according to claim 1, further comprising a programmable gate array, wherein said video controller is programmed into said programmable gate array.

7. The machine tool controller according to claim 6, wherein said dual-port memory is programmed into said programmable gate array.

8. The machine tool controller according to claim 1, further comprising a data buffer configured to buffer data communicated between said processor and said video controller.

9. The machine tool controller according to claim 8, further comprising a programmable gate array, wherein said data buffer is programmed into said programmable gate array.

10. The machine tool controller according to claim 8, wherein said data buffer is a first-in-first-out data buffer.

11. The machine tool controller according to claim 1, wherein the second, third, fourth, fifth and sixth interfaces comprise a dynamically configurable communications interface.

12. The machine tool controller according to claim 1, further comprising a serial port coupled to said processor via a serial port controller, wherein said serial port is further coupled to a user interface and is configured to receive user input for controlling the machine tool.

13. The machine tool controller according to claim 1, further comprising a debug port coupled to said processor via a seventh interface, wherein said debug port is configured to provide access to debug information within said processor.

14. The machine tool controller according to claim 1, further comprising a printed circuit board, wherein the elements of said machine tool controller are arranged and interconnected on said printed circuit board.

15. A machine tool control system, comprising:
a machine tool controller according to claim 1; and
a motor controller coupled to said machine tool controller via said external bus interface, wherein said motor controller is configured to control operation of a machine tool in accordance with control commands received from said machine tool controller.

16. The machine tool control system according to claim 15, further comprising a user interface coupled to said machine tool controller, wherein said user interface is configured to receive and communicate user input to said machine tool controller for controlling the operation of the machine tool.

17. The machine tool control system according to claim 16, wherein the user display is arranged within said user interface.

18. The machine tool control system according to claim 16, wherein said user interface comprises a remote jog handle coupled to said machine tool controller, wherein said remote jog handle is configured to receive and communicate user input to said machine tool controller for controlling a jogging operation of the machine tool.

19. A computer numerical controlled machine tool, comprising:
a machine tool; and
a machine tool control system according to claim 15, wherein said machine tool control system is coupled to said machine tool and wherein said machine tool is configured to manipulate a workpiece under the control of said machine tool control system.
